(19) United States
(12) Patent Application Publication
(10) Pub. No.: US 2009/0319405 A1
(43) Pub. Date: Dec. 24, 2009

(54) AUDITING SYSTEM AND AUDITING METHOD

(75) Inventor: Tsutomu Kawai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/547,255

(22) Filed: Aug. 25, 2009

Related U.S. Application Data
(63) Continuation of application No. PCT/JP2007/056490, filed on Mar. 27, 2007.

(51) Int. Cl. G06Q 10/00

(52) U.S. Cl. 705/30

(57) ABSTRACT

An auditing apparatus in an auditing system receives entire logs including a hashed log in which a log about another customer is hashed by a one-way function, and a log of a subject customer from a log storage server of a center. The center receives all the management logs, and the auditing apparatus generates a management log in which all the logs of the subject customers are hashed among the received management logs, and receives the entirely hashed management log from the hashed log publishing sever of the center. The auditing apparatus compares the management log hashed by itself, and the received management log (hashed) with each other, and verifies log validity.

### CROSS-REFERENCE TO RELATED APPLICATION(S)

This application is a continuation of PCT international application Ser. No. PCT/JP2007/056490 filed on Mar. 27, 2007 which designates the United States, incorporated herein by reference, the entire contents of which are incorporated herein by reference.

### FIELD

The embodiments discussed herein are directed to a computer readable storage medium containing an auditing program, an auditing system, and an auditing method with which validity of a log used in audit is verified by receiving the log from a server at which a plurality of customers shares resources.

### BACKGROUND

Conventionally, in a service provided by using a server at which customers share resources (for example, on-demand service), the customers audit operational status of a center. For example, when specific billing based on an amount of service provided is implemented in an on-demand service, only a data center that operates service can know the amount of service provided. Although this has never become a matter of concern because the amount of service provided and billing do not relate to each other in fixed billing in a conventional resource-fixed allocation, customers might become suspicious of a billing amount unless the center proves that a measured value is not falsified in specific billing in which the value measured by the center matters.

To solve this problem, operational policies are defined by the center, technical measures are taken, and audit is implemented to prove that the operational policies and the technical measures are surely implemented. For example, Japanese Laid-open Patent Publication No. 2002-41456, and Japanese Laid-open Patent Publication No. 2004-295303 disclose techniques of collecting logs used in audit from a server, and accumulating the logs. Operational status of a center can be audited by using the logs accumulated by using the techniques.

The conventional art explained above has a problem that personal information of customers cannot be protected appropriately because a log of a subject customer is made open also to other customers when customers share resources, and information of the customers are mixedly present in a server that stores therein logs used in audit.

The conventional art also has a problem that appropriate audit cannot be performed because an audit result cannot be sufficiently credible if all the logs are not referred to when only a log of a subject customer is audited by separating logs for customers in a system at which customers share resources.

### SUMMARY

According to an aspect of the invention, a computer readable storage medium contains instructions for implementing an auditing method of verifying validity of a log used in audit by receiving the log from a server at which a plurality of customers shares resources. The instructions, when executed by a computer, cause the computer to perform receiving entire logs including a hashed log in which a log about another customer is hashed by a one-way function, and a log of a subject customer from the server; hashing an unlashed log among the entire logs received at the receiving of the entire logs to generate a hashed log; receiving the hashed log in which the entire logs are hashed; and comparing the hashed log generated at the generating of the hashed log, and the hashed log received at the receiving of the hashed log with each other to verify log validity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic for explaining an auditing system according to a first embodiment of the present invention;

FIG. 2 is a block diagram of a configuration of a center according to the first embodiment;

FIG. 3 is a table for explaining an example of a server log;

FIG. 4 is a table for explaining an example of a management log;

FIG. 5 is a table for explaining an example of an audit log;

FIG. 6 is a table for explaining an example of a hashed management log;

FIG. 7 is a schematic for explaining a process of generating different logs from a common log;

FIG. 8 is a schematic for explaining hashing and signature generation;

FIG. 9 is a schematic for explaining an entire signature;

FIG. 10 is a block diagram of an auditing apparatus according to the first embodiment;

FIG. 11 is a table for explaining an example of a server log stored in a server log storage unit;

FIG. 12 is a table for explaining an example of a management log stored in a management log storage unit;

FIG. 13 is a table for explaining an example of an audit log stored in an audit log storage unit;

FIG. 14 is a table for explaining an example of a hashed management log stored in a hashed management log storage unit;

FIG. 15 is a table for explaining a hashed audit log stored in a hashed audit log storage unit;

FIG. 16 is a schematic for explaining a log verifying process;

FIG. 17 is a schematic for specifically explaining a signature verifying process;

FIG. 18 is a schematic for explaining a log verifying process;

FIG. 19 is a flowchart of the log verifying process by the auditing apparatus according to the first embodiment;

FIG. 20 is a flowchart of the log verifying process by the auditing apparatus according to the first embodiment;

FIG. 21 is a flowchart of the log verifying process by the auditing apparatus according to the first embodiment;

FIG. 22 is a flowchart of the log verifying process by the auditing apparatus according to the first embodiment;

FIG. 23 is a flowchart of the log verifying process by the auditing apparatus according to the first embodiment;

FIG. 24 is a flowchart of the hashed log verifying process by the auditing apparatus according to the first embodiment;

FIG. 25 is a schematic for explaining an auditing system according to a second embodiment of the present invention; and

FIG. 26 is a schematic of a computer that executes an auditing program.

### DESCRIPTION OF PREFERRED EMBODIMENTS

Preferred embodiments of an auditing system according to the present invention are explained in detail with reference to the attached drawings.

### [a] First Embodiment

In the following embodiment, an auditing system, a configuration of a center, and a configuration and a flow of process of an auditing apparatus according to a first embodiment of the present invention are explained sequentially, and an effect of the first embodiment is explained in the end.

### Auditing System According to First Embodiment

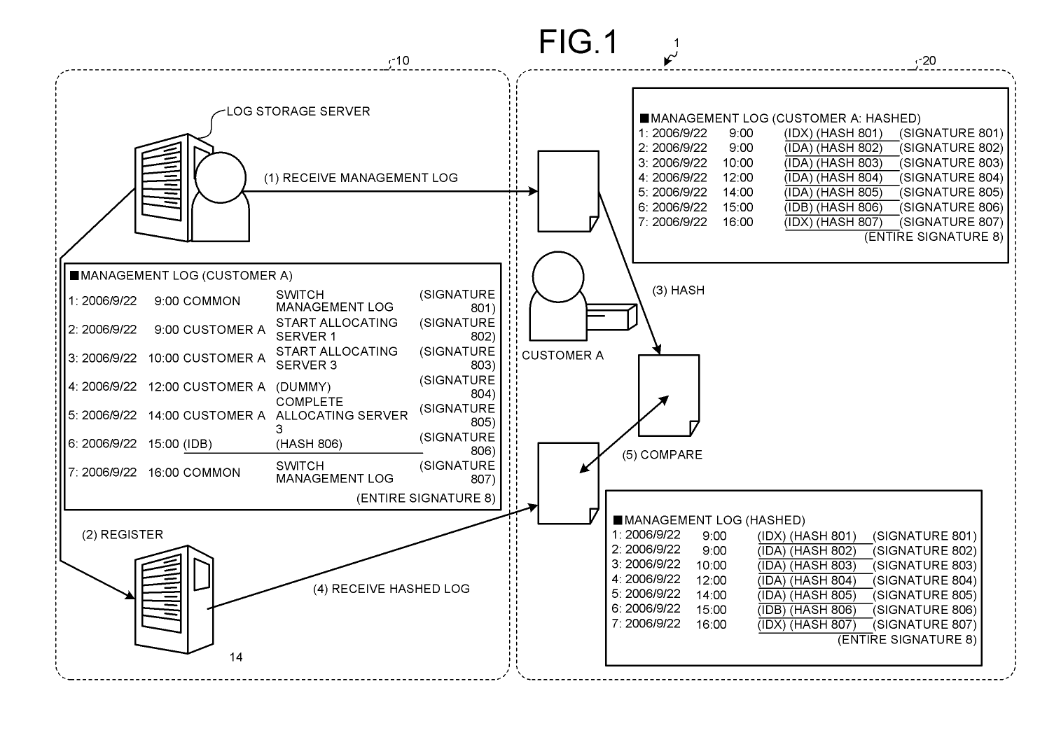

The auditing system according to the first embodiment is explained using FIG. 1. FIG. 1 is a schematic for explaining the auditing system according to the first embodiment.

In an auditing system 1 according to the first embodiment, a log used in audit is received from a server at which customers share resources, and then validity of the log is verified. Personal information of a customer is protected, and appropriate audit is executed.

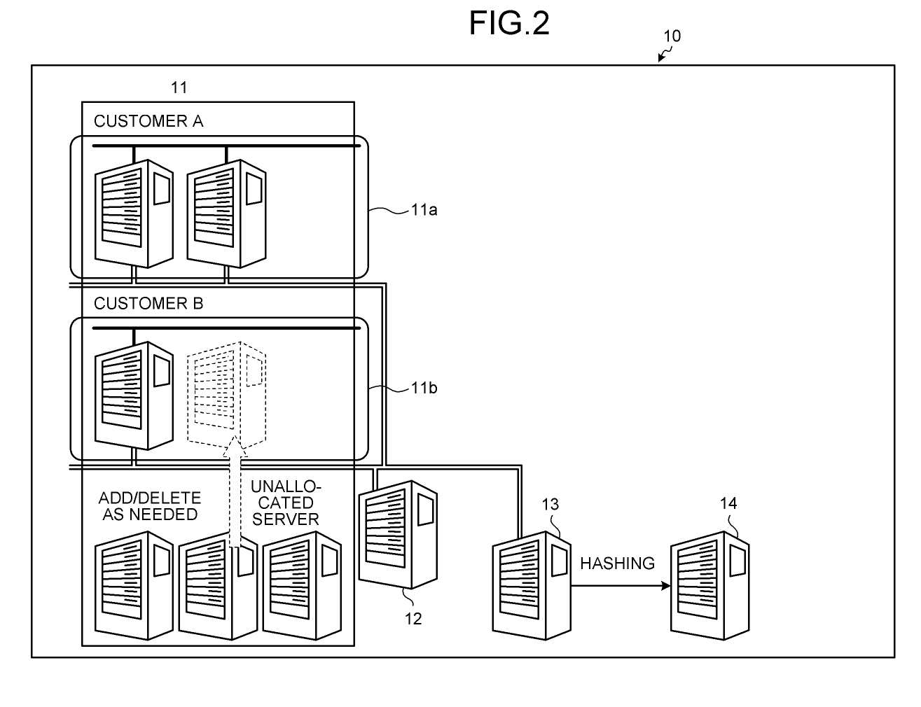

Specifically, the auditing system 1 includes a center 10 that provides various services, and manages logs of servers (a management server, a log storage server, and a hashed log publishing server explained in detailed using FIG. 2 below), and an auditing apparatus that audits operational status of the center 10, and the center 10 and the auditing apparatus are connected with each other through a network (not depicted).

In such a configuration, as depicted in FIG. 1, an auditing apparatus 20 of the auditing system 1 according to the first embodiment receives entire logs (management log (customer A) in the example of FIG. 1) including a hashed log in which a log of another customer is hashed by a one-way function and a log of a subject customer from a log storage server 13 of the center 10 (see (1) in FIG. 1). The center 10 registers the hashed log obtained by hashing all the management logs in the hashed log publishing server (see (2) in FIG. 1).

The auditing apparatus 20 generates an entirely hashed management log by hashing the log of the subject customer among the received management logs (management log (customer A: hashed) in the example of FIG. 1) (see (3) in FIG. 1), and receives an entirely hashed management log from the hashed log publishing sever of the center 10 (management log (hashed) in the example of FIG. 1) (see (4) in FIG. 1)).

The auditing apparatus 20 compares the management log hashed by itself (customer A: hashed), and the received management log (hashed) with each other, and verifies the validity of the log (see (5) in FIG. 1)). Specifically, the auditing apparatus 20 compares the management log (customer A: hashed), and the management log (hashed) with each other, and determines whether they match with each other. If they do not match, the auditing apparatus 20 outputs an error message that the logs do not match with each other to a predetermined output unit. On the other hand, if the logs match with each other, the auditing apparatus 20 judges that the log is valid, and the log is not falsified.

In this manner, the auditing system 1 hashes information about another customer by a one-way function to maintain its confidentiality, and makes it possible to refer to the entire logs; as a result, it becomes possible to protect personal information of a customer, and to execute appropriate audit.

<Configuration of Center>

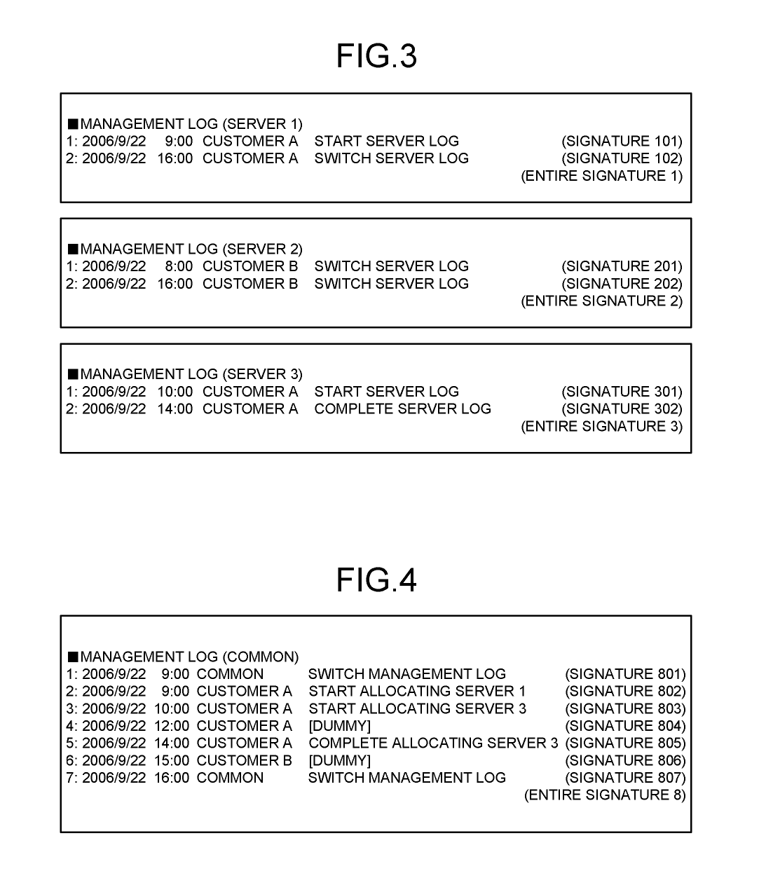

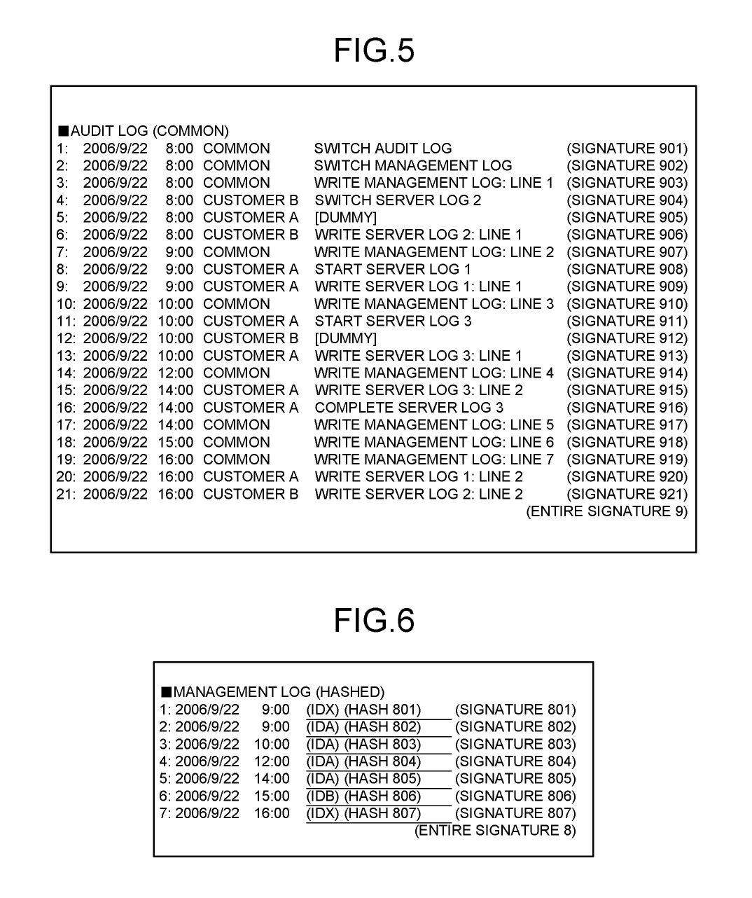

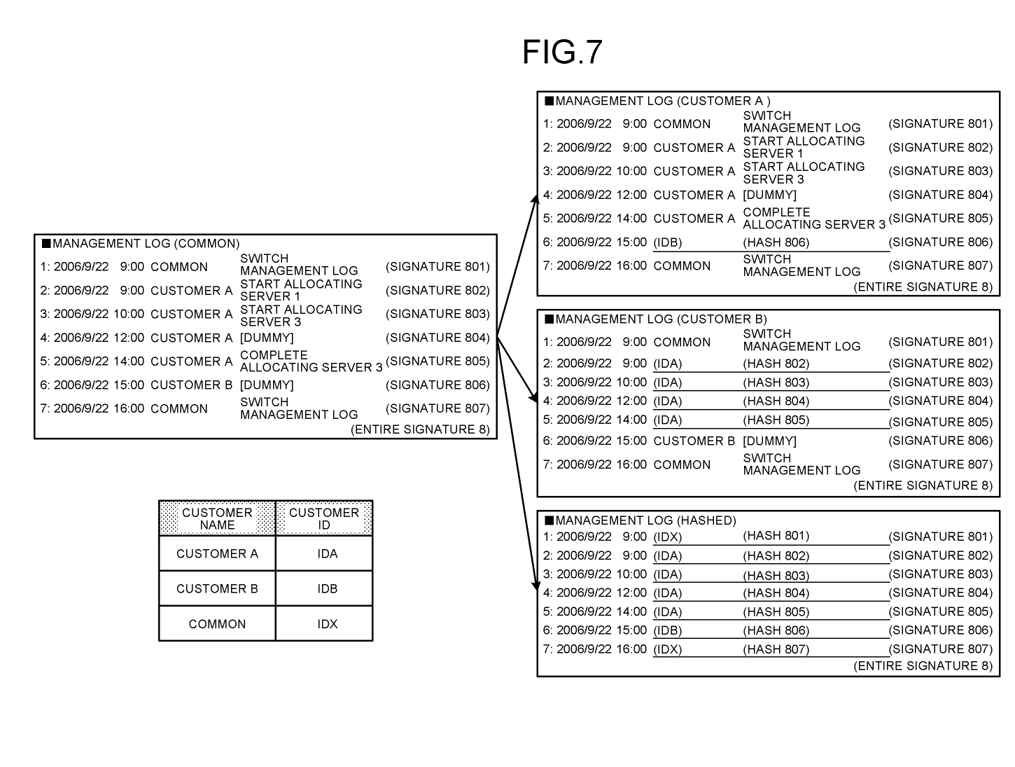

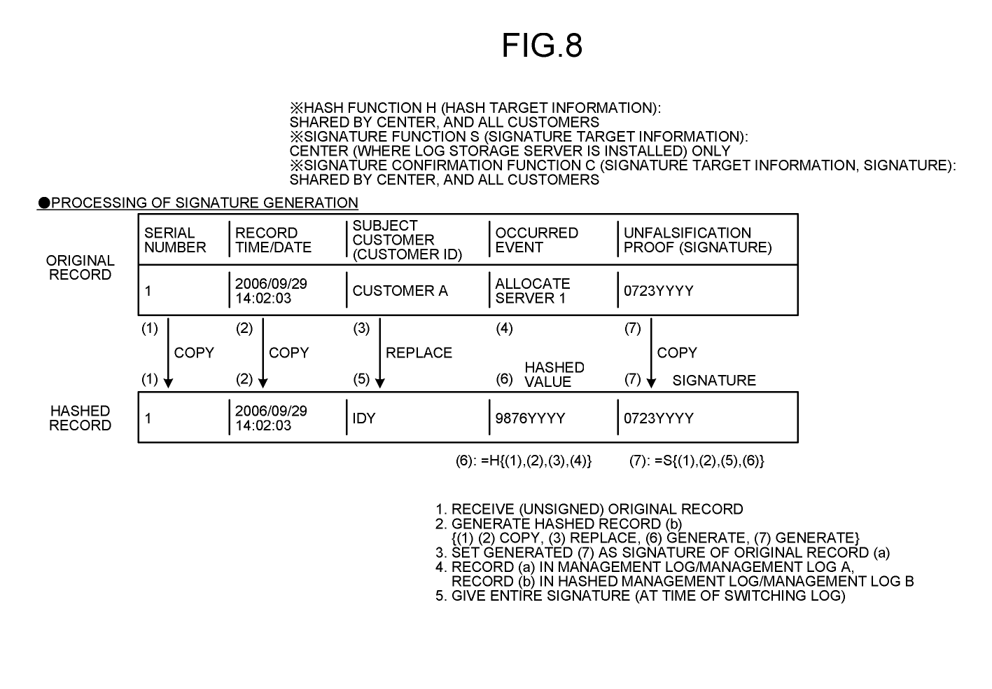

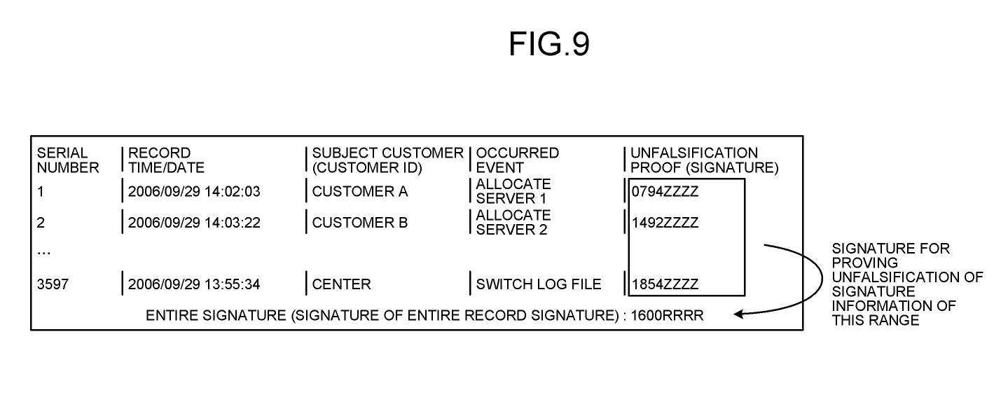

The configuration of the center 10 depicted in FIG. 1 is explained using FIG. 2. FIG. 2 is a block diagram of the configuration of the center 10 according to the first embodiment. FIG. 3 is a table for explaining an example of a server log. FIG. 4 is a table for explaining an example of a management log. FIG. 5 is a table for explaining an example of an audit log. FIG. 6 is a table for explaining an example of a hashed management log. FIG. 7 is a schematic for explaining a process of generating different logs from a common log. FIG. 8 is a schematic for explaining hashing and signature generation. FIG. 9 is a schematic for explaining an entire signature.

As depicted in FIG. 2, the center 10 includes a server (server pool) 11 used by customers, a management server 12, the log storage server 13, and a hashed log publishing server 14, all of which are connected with each other through a bus or the like. It is assumed that security policies and operation rules are established for the entire configuration, and that it is possible to confirm by audit on technical and operational status or the like that a stored log is maintained unfalsified.

The server pool 11 includes a plurality of servers (allocated servers, and unallocated servers), and allocates unallocated servers as servers to be used to customers as needed, making them allocated servers. Each server within the server pool 11 stores in a log file a server log (for example, operational history or the like of an application) as log information in the server, and regularly outputs the server log to the log storage server 13. The log information is output by a server allocated exclusively to a customer, and each customer can refer to a server log that is currently exclusive to him/her.

Specifically, as exemplified in FIG. 3, each server records, in the log file, one piece of log information (serial numbers, record time/date, subject customers, occurred events, and unfalsification proofs (signatures)) as a one-line log record. The “serial numbers” and the “record time/date” are used for prevention of log deficiency and ex-post falsification. The “subject customers” indicate which customers the log records are about. The “occurred events” show contents of actually recorded logs, and optional information may be filled in as the occurred events. The “unfalsification proofs (signatures)” are electric signatures for proving that the records are not modified after the time point when the records are recorded. The signature generation is explained below using FIG. 8. Among the electric signatures, an entire signature is an unfalsification signature given to signature information of an entire record within a log file at the time point when the log file is switched.

The management server 12 manages allocation status, configures a network, and the like, and stores therein a management log as log information in which logs about a plurality of customers (for example, audit information about server allocation, and operation, or the like) are mixedly present. Specifically, the management server 12 stores therein as log information a common log that is an original log file in which entire information is included (depicted in FIG. 4), and regularly outputs the common log to the log storage server 13.

The log storage server 13 records therein a server log output from each server, and a log of the management server, and stores therein audit information of the log storage server itself as an audit log in the log storage server (depicted in FIG. 5). At this time, the log storage server 13 separates the logs into pieces of information for the respective customers, records the information therein, generates a log of each customer in which information that should be published to all the customers, and a log related to the customer are recorded, and stores the log therein. The log storage server 13 generates a hashed management log (hashed), and outputs the hashed management log to the hashed log publishing server 14.

The process of generating different logs from a common management log performed by the log storage server 13 is explained using FIG. 7. As depicted in FIG. 7, the log storage server 13 generates a management log (customer A, customer B) for each customer, and a hashed management log (hashed) to be published via the hashed log publishing server 14 from a management log common to all the customers. Explaining using the example of FIG. 7, the log storage server 13 hashes “subject customers” other than the customer A, and “occurred events” about customers other than the customer A as the management log (customer A). The log storage server 13 hashes all the “subject customers”, and all the “occurred events” as the management log (hashed).

The log storage server 13 switches log files after a certain period (everyday, every week, every month, or the like) when the log storage server 13 stores therein logs for a long term, and switches log files also at the time point when a customer is switched to another customer.

The hashed log publishing server 14 further stores therein information for separation validity verification (hashed management log and audit log). Specifically, the hashed log publishing server 14 stores therein a management log obtained by hashing all the “subject customers” and all the “occurred events” (depicted in FIG. 6), and an audit log obtained by hashing all the “subject customers” and all the “occurred events”, and notifies the information when receiving a request from the auditing apparatus (customer) 20. The hashed log is acquired not via a center administrator, but from the hashed log publishing server 14 from which any customer can acquire the information anonymously.

The operation of generating a signature given to a log by each server, and hashing are explained using FIGS. 8 and 9. As depicted in FIG. 8, a customer name is converted into a customer ID that enables only confirmation of uniqueness. Each customer is notified of a customer ID of himself/herself, but a relationship of the customer ID with a customer ID of another customer is not notified. The correspondence of the customer ID with a customer may be changed for each log file, and in such a case, a customer ID of each customer is notified for each individual log file.

An occurred event is recorded after being converted into a hashed value using a one-way function. The hash function is assumed to be known by a center and all the customers. By following this procedure, the content of log information of other customers is disguised. However, because the flow of process might be guessed from the appearance frequency of log record only with the procedure, a dummy log record is inserted as information for disturbance. The dummy log record is inserted as a process for each customer at an appropriate frequency, and that this is dummy is described in the occurred event. Because information of serial numbers and record time/date are added at the time of hashing, and thus, even the same occurred events produce difference hashed values, an original event is not guessed from a hashed value of an occurred event.

A signature of a log record is generated based on information of a hashed record. A signature of a customer is verified after a process equivalent to hashing. By doing so, a hashed log record, and a signature of an original log record can be made the same, and the signature can be used in confirming unfalsification even at the time of verification described below. As depicted in FIG. 9, an unfalsification signature is generated as an entire signature, and given to signature information of an entire record within a log file at the time point when the log file is switched.

<Configuration of Auditing Apparatus>

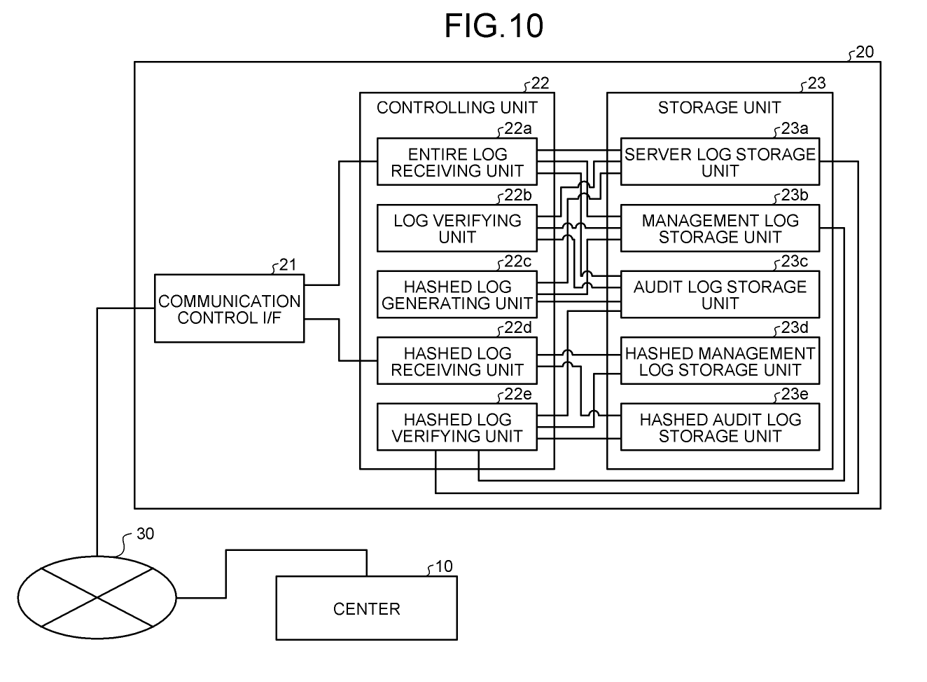

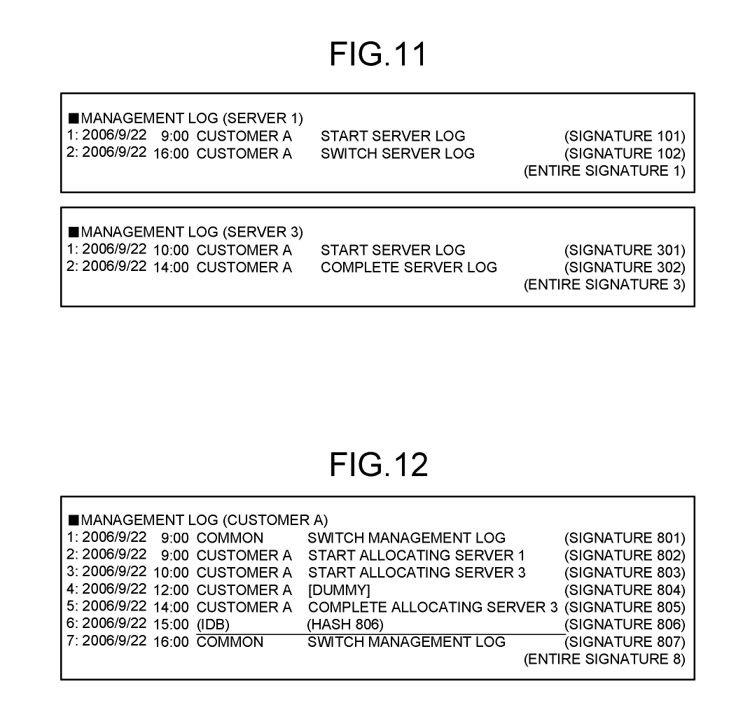

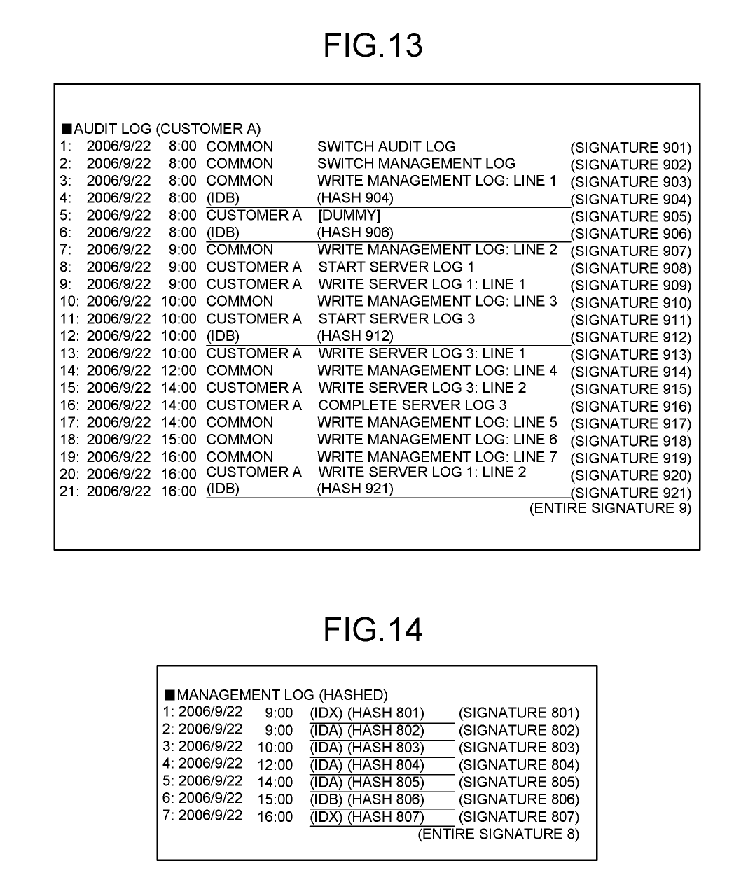

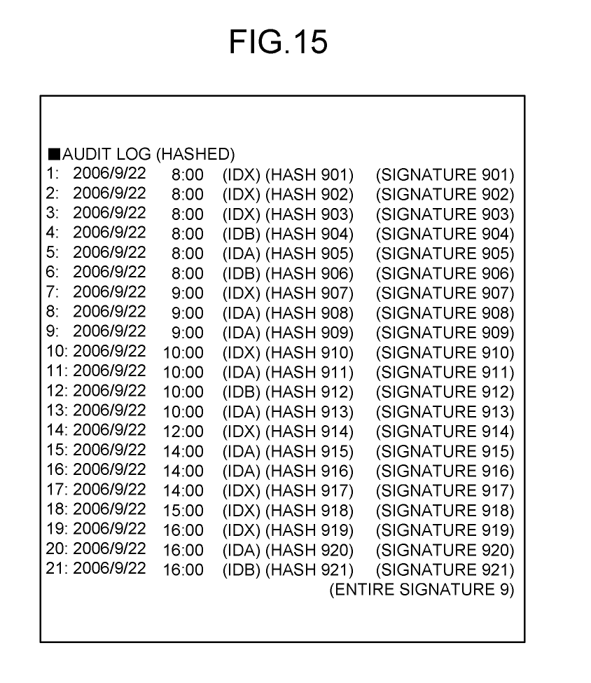

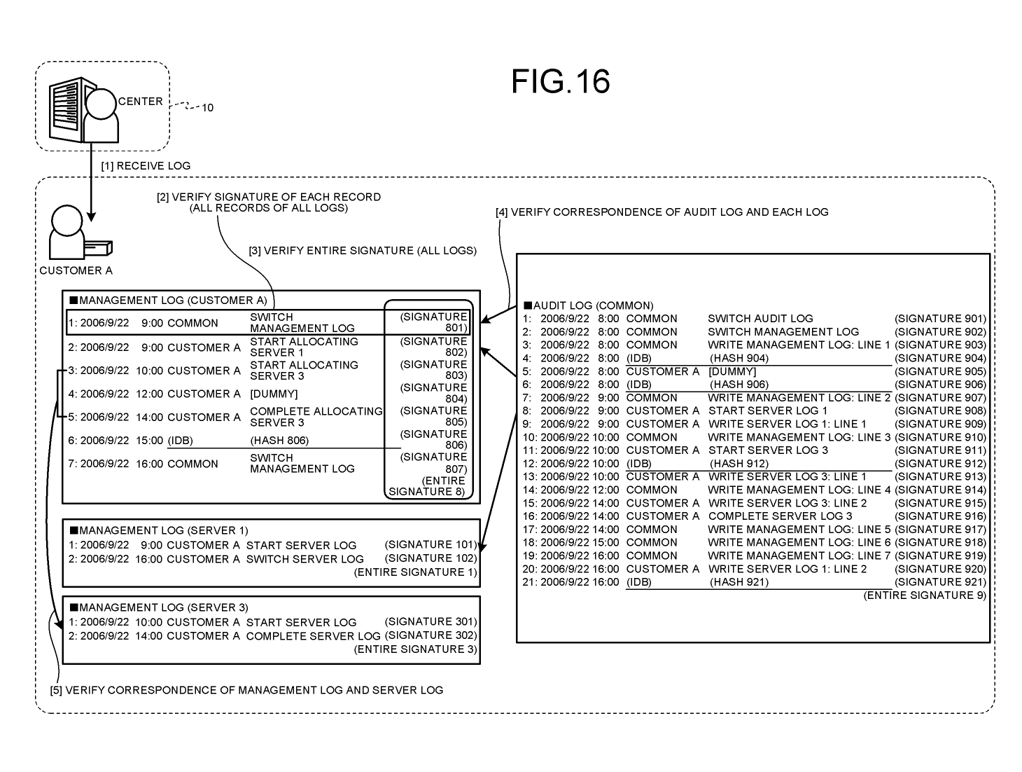

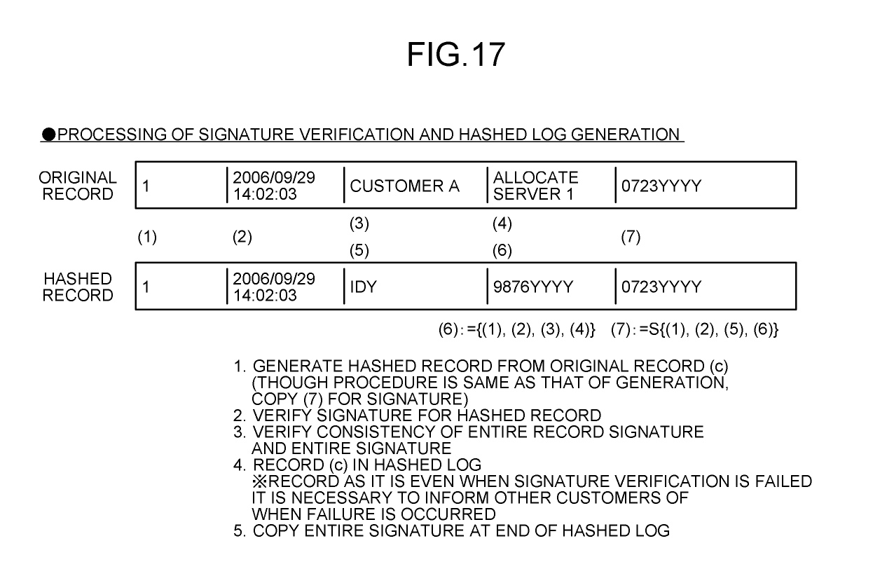

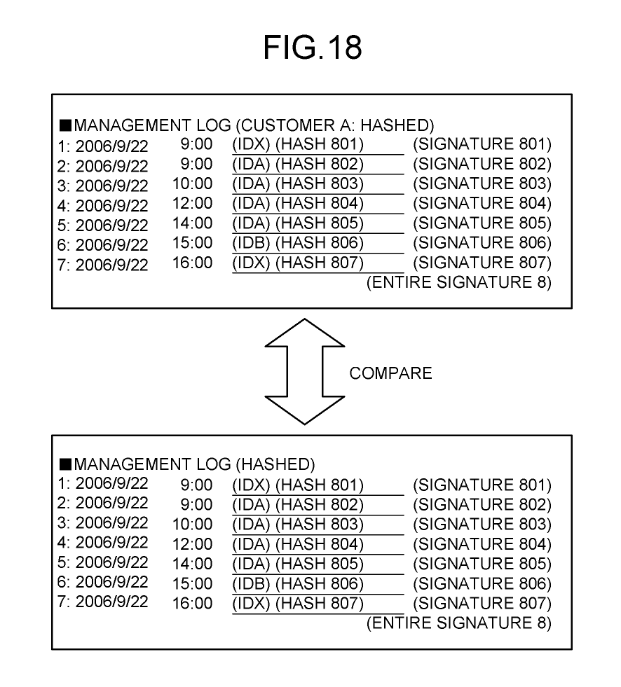

The configuration of the auditing apparatus 20 depicted in FIG. 1 is explained using FIG. 10. FIG. 10 is a block diagram of the auditing apparatus 20 according to the first embodiment. FIG. 11 is a table for explaining an example of a server log stored in the server log storage unit. FIG. 12 is a table for explaining an example of a management log stored in the management log storage unit. FIG. 13 is a table for explaining an example of an audit log stored in the audit log storage unit. FIG. 14 is a table for explaining an example of a hashed management log stored in the hashed management log storage unit. FIG. 15 is a table for explaining an example of a hashed audit log stored in the hashed audit log storage unit. FIG. 16 is a schematic for explaining a log verifying process. FIG. 17 is a schematic for specifically explaining a signature verifying process. FIG. 18 is a schematic for explaining a log verifying process.

As depicted in FIG. 10, the auditing apparatus 20 includes a communication control I/F 21, a controlling unit 22, and a storage unit 23, and is connected to the center 10 via a network 30. The process of each unit is explained below.

The communication control I/F 21 controls communication of various pieces of information exchanged with the connected center 10. Specifically, the communication control I/F 21 receives information about a log from the center 10.

The storage unit 23 stores therein data and computer programs necessary for each process operated by the controlling unit 22, and includes, especially as those related closely to the present invention, a server log storage unit 23a, a management log storage unit 23b, an audit log storage unit 23c, a hashed management log storage unit 23d, and a hashed audit log storage unit 23e.

The server log storage unit 23a stores therein a server log received from the log storage server 13 of the center 10. Specifically, as depicted in FIG. 11, the server log storage unit 23a stores therein server logs of a server 1 and a server 3 that the customer A uses. The server log storage unit 23a stores, in a log file, one piece of log information (serial numbers, record time/date, subject customers, occurred events, and unfalsification proofs) as a one-line log record.

The management log storage unit 23b stores therein a management log received from the log storage server 13 of the center 10. Specifically, as depicted in FIG. 12, the management log storage unit 23b stores therein a management log (customer A) obtained by hashing “subject customers” other than the customer A and “occurred events” about customers other than the customer A, but not hashing information common to all the customers and information of the customer A himself/herself. In other words, because the customer A cannot browse information about other customers, personal information is appropriately protected.

The audit log storage unit 23c stores therein an audit log received from the log storage server 13 of the center 10. Specifically, as depicted in FIG. 13, the audit log storage unit 23c stores therein an audit log (customer A) obtained by hashing “subject customers” other than the customer A and “occurred events” about customers other than the customer A, but not hashing information common to all the customers and information of the customer A himself/herself, as well as the management log (customer A).

The hashed management log storage unit 23d stores therein a management log (hashed) hashed by a hashed log generating unit 22c explained below. Specifically, as depicted in FIG. 14, the hashed management log storage unit 23d stores therein a management log (hashed) obtained by hashing all the “subject customers” and all the “occurred events”.

The hashed audit log storage unit 23e stores therein an audit log (hashed) hashed by the hashed log generating unit 22c explained below. Specifically, as depicted in FIG. 15, the hashed audit log storage unit 23e stores therein an audit log (hashed) obtained by hashing all the “subject customers” and all the “occurred events”, as well as the management log (hashed).

The controlling unit 22 includes an internal memory for storing therein computer programs that define various process procedures and the like, and required data, and executes various processes by these computer programs and data. The controlling unit 22 includes, as those closely related to the present invention, an entire log receiving unit 22a, a log verifying unit 22b, the hashed log generating unit 22c, a hashed log receiving unit 22d, and a hashed log verifying unit 22e.

The entire log receiving unit 22a receives logs including a hashed log obtained by hashing a log about another customer by a one-way function, and a log of a subject customer (management log, and audit log) from the log storage server 13 of the center 10. Specifically, the entire log receiving unit 22a notifies the center 10 of performing audit, receives, from the log storage server 13 of the center 10, a server log of a server used by a customer to whom the notification is sent from the center 10 receiving the notification, a management log, and an audit log obtained by hashing logs about another customer by a one-way function, and stores them in the server log storage unit 23a, the management log storage unit 23b, and the audit log storage unit 23c, respectively.

The log verifying unit 22b verifies whether the received server log, the management log, and the audit log do not contradict with each other. Specifically, as depicted in FIG. 16, when the entire log receiving unit 22a receives a log from the center 10, the log verifying unit 22b verifies a log file for each record. The log verifying unit 22b verifies that a log file is not falsified for each record by confirming that a signature given to a record is valid. The log verifying unit 22b also confirms consistency of serial numbers of records, orderliness of record time/date, and appropriateness of occurred events themselves. An entire signature of a log file is verified.

The log verifying unit 22b verifies whether the entire signature given to signatures of all the records in a log file is appropriate, and confirms that a record is not added, deleted, or replaced. Then, the log verifying unit 22b confirms correspondence of whether a record corresponding to a logging operation described in an audit log exists for each log. Thereby, the log verifying unit 22b confirms that a change is not made in a log without involvement of the log storage server. The log verifying unit 22b confirms correspondence of server assignment information in a management log and a server log. Thereby, deficiency and excess of a server log is verified.

A signature verifying process is explained using FIG. 17. The log verifying unit 22b hashes an original record to generate a hashed record, and verifies a signature of the hashed record. Then, the log verifying unit 22b verifies consistency between the entire record signature and the entire signature. The verifying process is explained in detail below using the flow of the process.

The hashed log generating unit 22c hashes a log of a subject customer among the received management log and the received audit log, and generates an entirely hashed management log and an entirely hashed audit log. Specifically, the hashed log generating unit 22c generates a management log (customer A: hashed) and an audit log (customer A: hashed) obtained by hashing a “subject customer” and an “occurred event” of a subject customer among the management log and the audit log stored in the management log storage unit 23b and the audit log storage unit 23c, and stores them in the hashed management log storage unit 23d and the hashed audit log storage unit 23e, respectively.

The hashed log receiving unit 22d receives the management log (hashed) obtained by hashing an entire management log from the hashed log publishing server of the center 10. Specifically, the hashed log receiving unit 22d receives the management log (hashed) obtained by hashing an entire management log from the hashed log publishing server of the center 10, and notifies the hashed log verifying unit 22e explained below of the received log.

The hashed log verifying unit 22e compares the management log hashed by itself (customer A: hashed) and the received management log (hashed), and verifies validity of the log. Specifically, as depicted in FIG. 18, the hashed log verifying unit 22e compares the management log (customer A: hashed) and the management log (hashed) with each other to determine whether they match. If they do not match, the hashed log verifying unit 22e outputs an error message that the logs do not match with each other to a predetermined output unit. On the other hand, if the logs match with each other, the auditing apparatus 20 judges that the log is valid, and is not falsified.

<Process Operated by Auditing Apparatus>

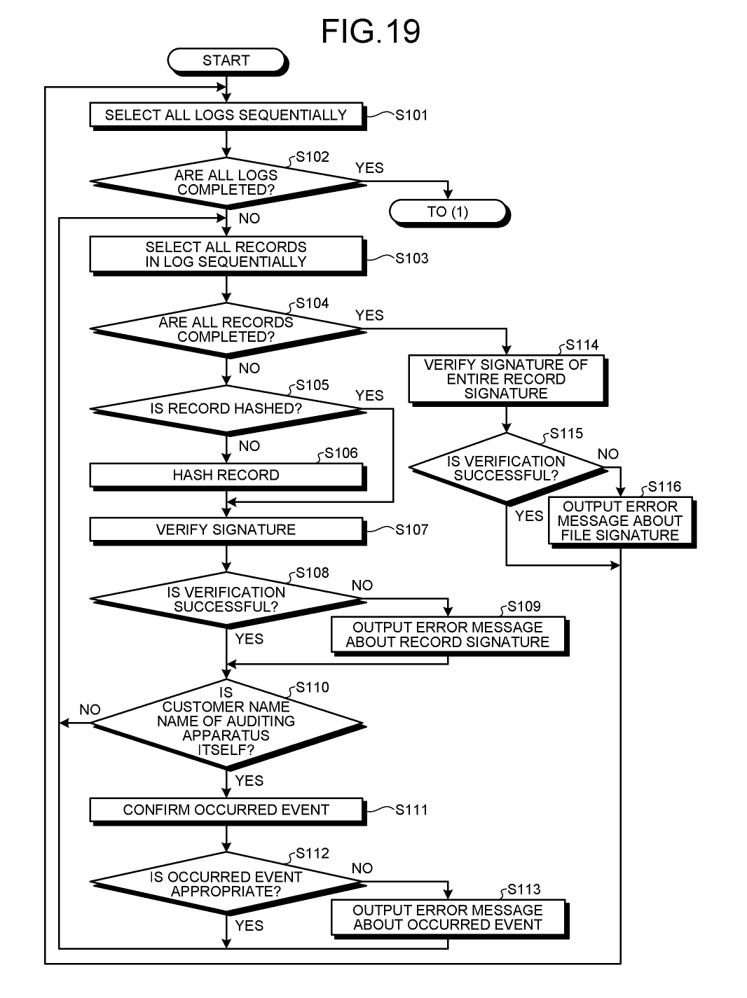

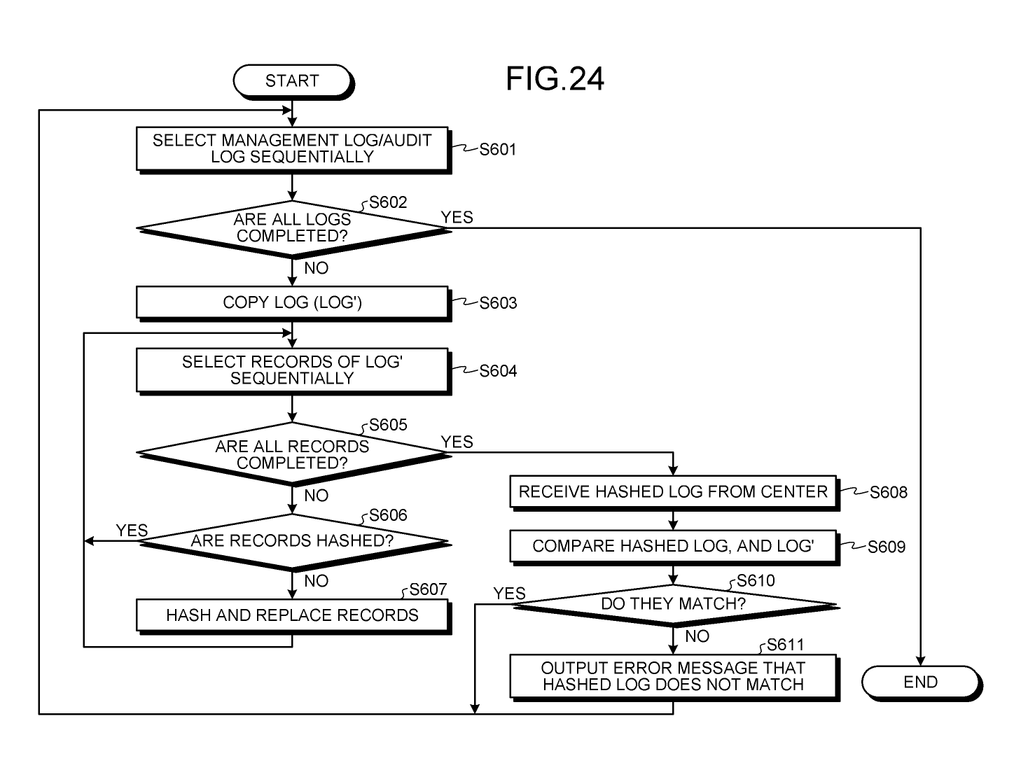

The process operated by the auditing apparatus 20 according to the first embodiment is explained using FIGS. 19 to 24. FIGS. 19 to 23 are flowcharts of the log verifying process by the auditing apparatus according to the first embodiment. FIG. 24 is a flowchart of the hashed log verifying process by the auditing apparatus according to the first embodiment.

The flow of the log verifying process by the auditing apparatus 20 is explained using FIGS. 19 to 23. Upon receiving a server log, a management log, and an audit log from the center 10, the auditing apparatus 20 selects all the logs sequentially (Step S101), and determines whether verification of signatures of all the logs is completed (Step S102). If the verification of signatures of all the logs is not completed (NO at Step S102), the auditing apparatus 20 selects all the records in a log sequentially (Step S103), and determines whether all the records are completed (Step S104).

If all the records are not completed (NO at Step S104), the auditing apparatus 20 determines whether a record is hashed (Step S105). After the auditing apparatus 20 hashes the record (Step S106) if the record is not hashed (NO at Step S105), or after it is determined that the record is hashed (YES at Step S105), the auditing apparatus 20 verifies a signature (Step S107).

The auditing apparatus 20 determines whether verification is successful (Step S108), and if not (NO at Step S108), outputs an error message about record signature (Step S109). If the verification is successful (YES at Step S108), the auditing apparatus 20 determines whether the customer name is the name of the auditing apparatus 20 itself (Step S110). If the customer name is not the name of the auditing apparatus 20 itself (NO at Step S110), the process returns to Step S103. If the customer name is the name of the auditing apparatus 20 itself (YES at Step S110), the auditing apparatus 20 confirms an occurred event (Step S111), and determines whether the occurred event is appropriate (Step S112).

As a result, after the auditing apparatus 20 outputs an error message about occurred event (Step S113) if the occurred event is not appropriate (NO at Step S112), or after it is determined that the occurred event is appropriate (YES at Step S112), the process returns to Step S103.

At Step S104, if all the records are completed (YES at Step S104), the auditing apparatus 20 verifies a record signature and an entire signature (Step S114), and determines whether the verification is successful (Step S115). As a result, after the auditing apparatus 20 outputs an error message about file signature (Step S116) if the verification is not successful (NO at Step S115), or after it is determined that the verification is successful (YES at Step S115), the process returns to Step S101.

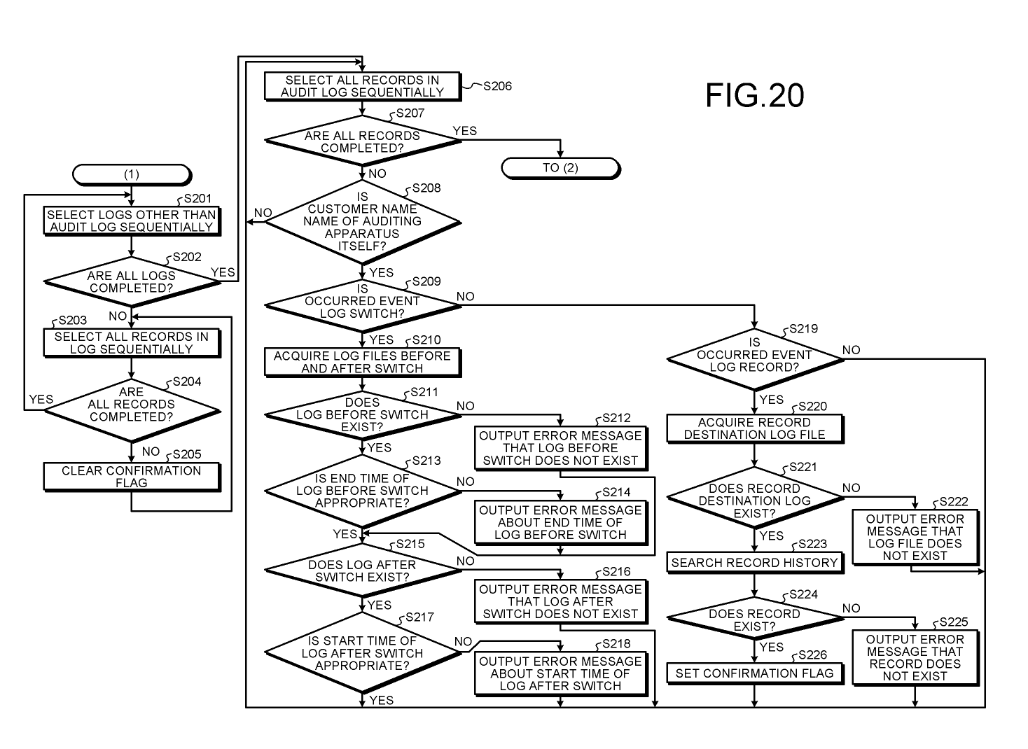

At Step S102, if the verification of all the logs is completed (YES at Step S102), the auditing apparatus 20, as depicted in FIG. 20, selects logs other than the audit log sequentially (Step S201), and determines whether all the logs are completed (Step S202). If all the logs are not completed (NO at Step S202), the auditing apparatus 20 selects all the records in a log sequentially (Step S203), and determines whether all the records are completed (Step S204). If all the records are not completed (NO at Step S204), the auditing apparatus 20 clears a confirmation flag (Step S205), and the process returns to Step S203. If all the records are completed (YES at Step S204), the process returns to Step S201.

At Step S202, if all the logs are completed (YES at Step S202), the auditing apparatus 20 selects all the records of the audit log sequentially (Step S206), and determines whether all the records are completed (Step S207). If all the records are not completed (NO at Step S207), the auditing apparatus 20 determines whether the customer name is the name of the auditing apparatus itself (Step S208). If the customer name is not the name of the auditing apparatus 20 itself (NO at Step S208), the process returns to Step S206. If the customer name is the name of the auditing apparatus 20 itself (YES at Step S208), the auditing apparatus 20 determines whether an occurred event is log switch (Step S209). If the occurred event is log switch (YES at Step S209), the auditing apparatus 20 acquires log files before and after the switch (Step S210), and determines whether a log before the switch exists (Step S211).

If a log before the switch does not exist (NO at Step S211), the auditing apparatus 20 outputs an error message that a log before the switch does not exist (Step S212). If a log before the switch exists (YES at Step S211), the auditing apparatus 20 determines whether the end time of the log before the switch is appropriate (Step S213). If the end time of the log before the switch is not appropriate (NO at Step S213), the auditing apparatus 20 outputs an error message about end time of the log before the switch (Step S214).

If the end time of the log before the switch is appropriate (YES at Step S213), the auditing apparatus 20 determines whether a log after the switch exists (Step S215). If a log after the switch does not exists (NO at Step S215), the auditing apparatus 20 outputs an error message that a log after the switch does not exists (Step S216). If a log after the switch exists (YES at Step S215), the auditing apparatus 20 determines whether the start time of the log after the switch is appropriate (Step S217). If the start time of the log after the switch is not appropriate (NO at Step S217), the auditing apparatus 20 outputs an error message about start time of the log after the switch (Step S218), and the process returns to Step S206.

At Step S209, if an occurred event is not log switch (NO at Step S209), the auditing apparatus 20 determines whether the occurred event is log record (Step S219). If the occurred event is not log record (NO at Step S219), the process returns to Step S206, and if the occurred event is log record (YES at Step S219), the auditing apparatus 20 acquires a record destination log file (Step S220), and determines whether a record destination log exists (Step S221). If a record destination log does not exists (NO at Step S221), the auditing apparatus 20 outputs an error message that a log file does not exist (Step S222), and the process returns to Step S206.

If a record destination log exists (YES at Step S221), the auditing apparatus 20 searches a record history (Step S223), and determines whether a record exists (Step S224). If a record does not exist (NO at Step S224), the auditing apparatus 20 outputs an error message that a record does not exist (Step S225), and on the other hand, if a record exists (YES at Step S224), the auditing apparatus sets a confirmation flag (Step S226), and the process returns to Step S206.

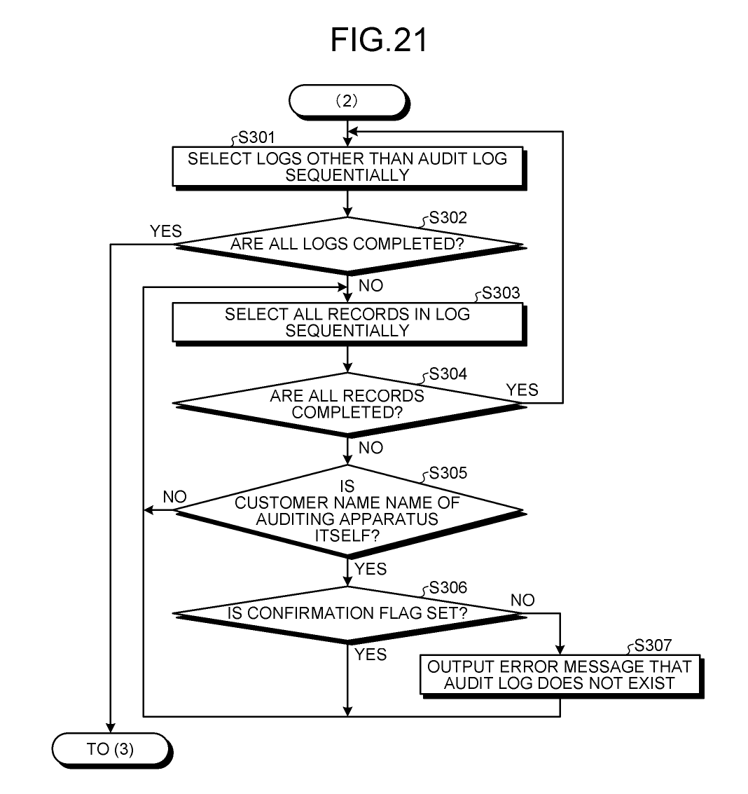

At Step S207, if all the records are completed (YES at Step S207), the auditing apparatus 20, as depicted in FIG. 21, selects logs other than the audit log sequentially (Step S301), and determines whether all the logs are completed (Step S302). If all the logs are not completed (NO at Step S302), the auditing apparatus 20 selects all the records in the log sequentially (Step S303), and determines whether all the records are completed (Step S304). If all the records are completed (YES at Step S304), the process returns to Step S301, and if all the records are not completed (NO at Step S304), the auditing apparatus 20 determines whether the customer name is the name of the auditing apparatus 20 itself (Step S305).

If the customer name is not the name of the auditing apparatus 20 itself (NO at Step S305), the process returns to Step S303, and if the customer name is the name of the auditing apparatus 20 itself (YES at Step S305), the auditing apparatus 20 determines whether a confirmation flag is set (Step S306). If a confirmation flag is not set (NO at Step S306), the auditing apparatus 20 outputs an error message that an audit log does not exist (Step S307), and if a confirmation flag is set (YES at Step S306), the process returns to Step S303.

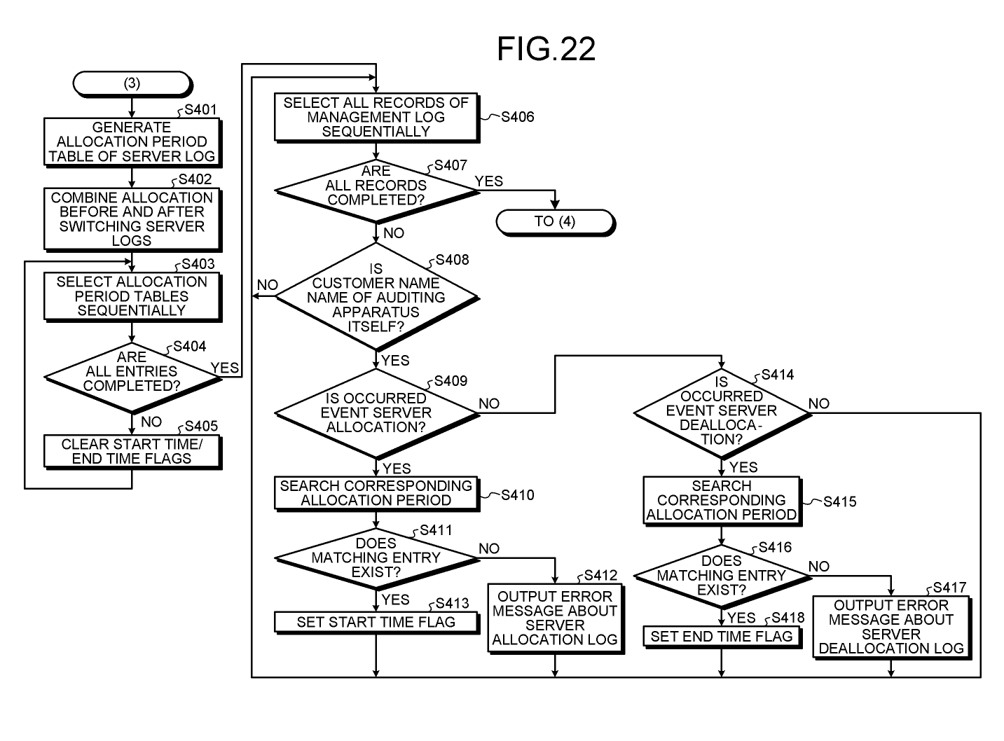

At Step S302, if all the logs are competed (YES at Step S302), the auditing apparatus 20, as depicted in FIG. 22, generates an allocation period table for storing therein time at which a server is allocated (Step S401). The auditing apparatus 20 combines allocation before and after the switch of server logs (Step S402), selects allocation period tables sequentially (Step S403), and determines whether all the entries are completed (Step S404). If all the entries are not completed (NO at Step S404), the auditing apparatus 20 clears flags of the start time and the end time (Step S405), and the process returns to Step S403.

On the other hand, if all the entries are completed (YES at Step S404), the auditing apparatus 20 selects all the records of a management log sequentially (Step S406), and determines whether all the records are completed (Step S407). If all the records are not completed (NO at Step S407), the auditing apparatus 20 determines whether the customer name is the name of the auditing apparatus 20 itself (Step S408). If the customer name is not the name of the auditing apparatus 20 itself (NO at Step S408), the process returns to Step S406, and if the customer name is the name of the auditing apparatus 20 itself (YES at Step S408), the auditing apparatus 20 determines whether the occurred event is server allocation (Step S409).

If the occurred event is server allocation (YES at Step S409), the auditing apparatus 20 searches a corresponding allocation period (Step S410), and determines whether a matching entry exists (Step S411). If a matching entry does not exist (NO at Step S411), the auditing apparatus 20 outputs an error message about server allocation log (Step S412), and the process returns to Step S406. If a matching entry exists (YES at Step S411), the auditing apparatus sets a start time flag (Step S413), and the process returns to Step S406.

At Step S409, if the occurred event is not server allocation (NO at Step S409), the auditing apparatus 20 determines whether the occurred event is server deallocation (Step S414). If the occurred event is not server deallocation (NO at Step S414), the process returns to Step S406, and if the occurred event is server deallocation (YES at Step S414), the auditing apparatus 20 search a corresponding allocation period (Step S415), and determines whether a matching entry exists (Step S416).

If a matching entry does not exist (NO at Step S416), the auditing apparatus 20 outputs an error message about the sever deallocation log (Step S417), and the process returns to Step S406. If a matching entry exists (YES at Step S416), the auditing apparatus 20 sets an end time flag (Step S418), and the process returns to Step S406.

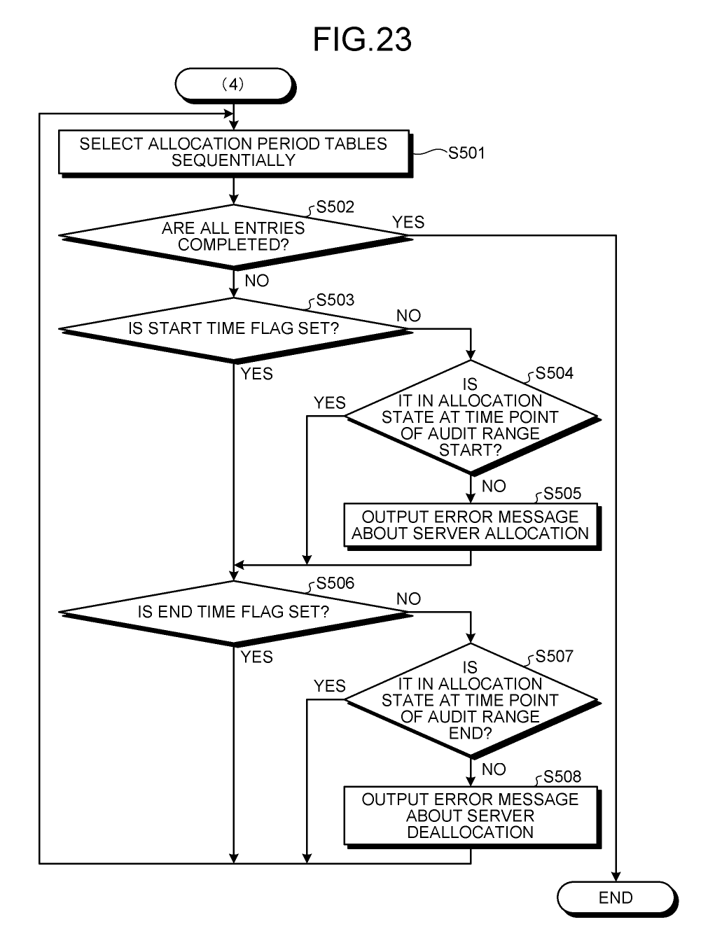

At Step S407, if all the records are completed (YES at Step S407), the auditing apparatus 20, as depicted in FIG. 23, selects allocation period tables sequentially (Step S501), and determines whether all the entries are completed (Step S502). If all the entries are completed (YES at Step S502), the auditing apparatus 20 ends the process. On the other hand, if all the entries are not completed (NO at Step S502), the auditing apparatus 20 determines whether a start time flag is set (Step S503).

If a start time flag is not set (NO at Step S503), the auditing apparatus 20 determines whether it is in an allocation state at the time point of audit range start (Step S504). If it is not in an allocation state at the time point of audit range start (NO at Step S504), the auditing apparatus 20 outputs an error message about server allocation (Step S505). If it is in an allocation state at the time point of audit range start (YES at Step S504), the auditing apparatus 20 determines whether an end time flag is set (Step S506).

If an end time flag is not set (NO at Step S506), the auditing apparatus 20 determines whether it is in an allocation state at the time point of audit range end (Step S507). If it is not in an allocation state at the time point of audit range end (NO at Step S507), the auditing apparatus 20 outputs an error message about server deallocation (Step S508), and the process returns to Step S501.

The hashed log verifying process is explained using FIG. 24. After performing the log verifying process, the auditing apparatus 20 selects a management log, and an audit log sequentially (Step S601), and determines whether all the logs are completed (Step S602). If all the logs are not completed (NO at Step S602), the auditing apparatus 20 copies logs (Step S603), selects records of the copied logs sequentially (Step S604), and determines whether all the records are completed (Step S605). If all the logs are completed (YES at Step S602), the auditing apparatus 20 ends the process.

If all the records are not completed (NO at Step S605), the auditing apparatus 20 determines whether the records are hashed (Step S606). If the records are not hashed (NO at Step S606), the auditing apparatus 20 hashes and replaces the records (Step S607), and the process returns to Step S604.

At Step S605, if all the records are completed (YES at Step S605), the auditing apparatus 20 receives a hashed log from the center 10 (Step S608), compares management log hashed by itself and a received management log with each other (Step S609), and determines whether they match with each other (Step S610). If the management log hashed by itself and the received management log do not match with each other (NO at Step S610), the auditing apparatus 20 outputs an error message that the hashed log does not match (Step S611). If the management log hashed by itself and the received management log match with each other (YES at Step S610), the auditing apparatus 20 determines that the log is valid, and the process returns to Step S601.

### Effects of First Embodiment

As explained above, validity of a log is verified by: receiving entire logs including a hashed log in which a log of another customer is hashed by a one-way function, and a log of a subject customer from the center 10; hashing an unlashed log among the received entire logs to generate a hashed log; receiving an entire hashed log in which all the logs are hashed; and comparing the generated hashed log and the received hashed logs with each other. Therefore, the entire logs can be referred to while maintaining confidentiality of information about another customer by hashing the information by a one-way function; as a result, it is possible to protect personal information of a customer, and execute appropriate audit.

According to the first embodiment, because a hashed log is received from the center 10 that manages each server, the hashed log is received directly from the center 10 without bypassing a third party; as a result, it is possible for example to easily identify a cause of falsification of a log, if found.

### [b] Second Embodiment

Although in the first embodiment, an entirely hashed log is received from the center 10, the present invention is not limited to this. An entirely hashed log may be received from another customer.

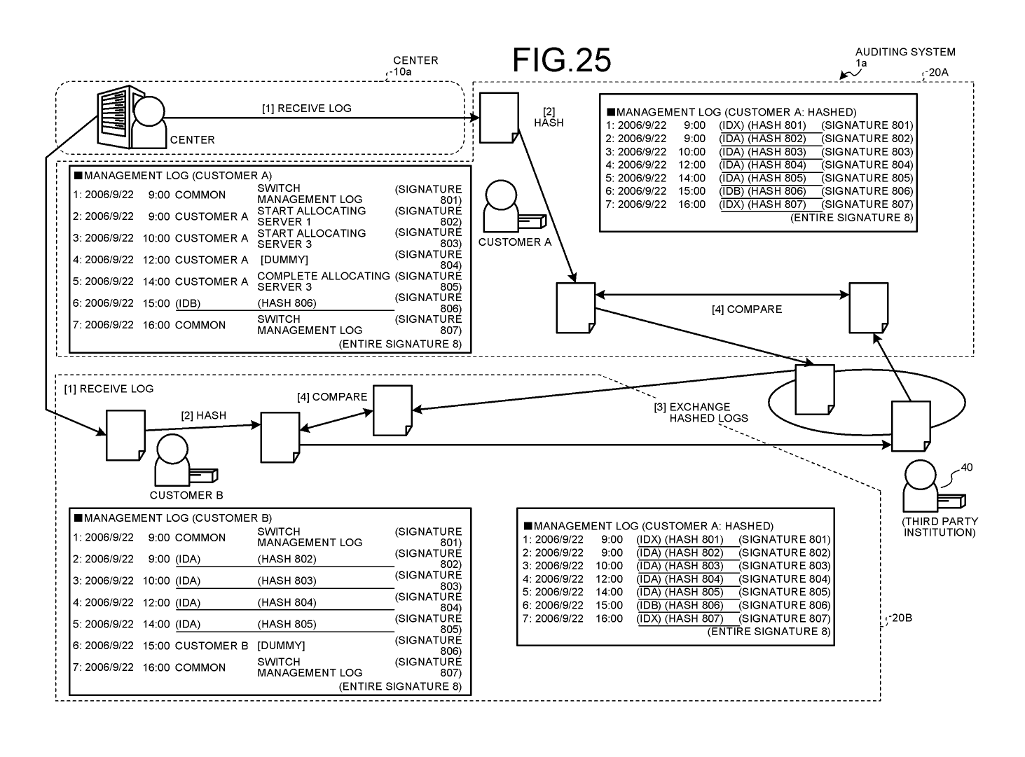

In a second embodiment of the present invention, a log is verified by receiving an entirely hashed log from another customer, and comparing the received hashed log and a log hashed by itself with each other. An auditing system la according to the second embodiment are explained using FIG. 25. FIG. 25 is a schematic for explaining the auditing system la according to the second embodiment.

First of all, the auditing system la according to the second embodiment are explained. As depicted in FIG. 25, each of auditing apparatuses 20A and 20B of the auditing system la receives the entire logs including a hashed log in which a log about another customer is hashed by a one-way function, and a log of a subject customer as in the first embodiment, and each customer hashes the log (see (1) and (2) in FIG. 25).

Unlike the first embodiment, in the auditing system la according to the second embodiment, the auditing apparatuses 20A and 20B of each customer exchange hashed logs with each other ((3) in FIG. 25). Although in the example of FIG. 25, logs are exchanged by mediation of a third party institution 40 to maintain anonymity, the present invention is not limited to this.

Thereafter, with the auditing apparatuses 20A and 20B of each customer, each customer compares a hashed log hashed by itself, and a hashed log generated by another customer with each other, and confirms whether a log received by himself/herself and a log received by another customer originate from a single common log (see (4) in FIG. 25).

As described above, in the second embodiment, a hashed log is received from another customer bypassing a third party, not directly from the center 10; as a result, it is possible to execute more appropriate audit.

### [c] Third Embodiment

Although preferred embodiments of the present invention are explained above, the present invention may be implemented in various different forms other than the embodiments explained above. Anther preferred embodiment of the present invention is explained below as a third embodiment of the present invention.

(1) System Configuration Etc.

Each component of each unit depicted in the drawings is conceptual in function, and is not necessarily physically configured as depicted. That is, the specific forms of dispersion and integration of the components are not meant to be restricted to those depicted in the drawings. All or part the components may be functionally or physically distributed or integrated in arbitrary units according to various kinds of load and the state of use. For example, the entire log receiving unit 22a and the log verifying unit 22b may be integrated. Furthermore, all or arbitrary part of the process functions performed in each component may be achieved by a Central Processing Unit (CPU) and a computer program analyzed and executed on the CPU, or may be achieved as hardware with a wired logic.

All or part of the processes explained as being automatically performed in the embodiments may be manually performed, or all or part of the processes explained as being manually performed may be automatically performed through a known method. In addition, the process procedure, the control procedure, specific names, and information inducing various kinds of data and parameters explained in the specification and depicted in the drawings may be arbitrarily changed unless otherwise specified.

(2) Computer Program

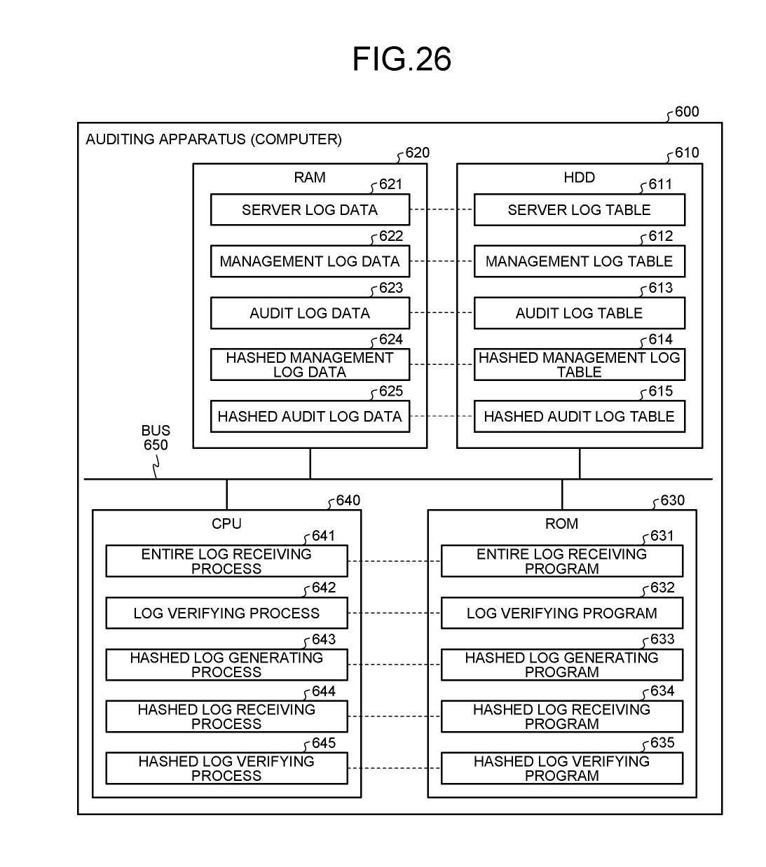

Various kinds of processes explained in the embodiments may be achieved by executing a previously prepared computer program with a computer. This program may be recorded on a computer-readable storage medium such as a floppy disc (FD), a CD-ROM, an MO, and a DVD. An example of a computer that executes a computer program having functions similar to those explained in the embodiments explained above is explained using FIG. 26. FIG. 26 is a schematic of the computer that executes an auditing program.

As depicted in FIG. 26, in a computer 600 as an auditing apparatus, a hard disk drive (HDD) 610, a random access memory (RAM) 620, a read only memory (ROM) 630, and a central processing unit (CPU) 640 are connected by a bus 650.

The ROM 630 stores therein an auditing program that exhibits functions similar to those of the embodiments described above, that is, an entire log receiving program 631, a log verifying program 632, a hashed log generating program 633, a hashed log receiving program 634, and a hashed log verifying program 635 as depicted in FIG. 26. Similarly to components of the auditing apparatus 20 depicted in FIG. 10, the programs 631 to 635 may be integrated or distributed appropriately.

When the CPU 640 reads out these programs 631 to 635 from the ROM 630, and executes them, the programs 631 to 635 function as an entire log receiving process 641, a log verifying process 642, a hashed log generating process 643, a hashed log receiving process 644, and a hashed log verifying process 645, respectively, as depicted in FIG. 26. The processes 641 to 645 correspond to the entire log receiving unit 22a, the log verifying unit 22b, the hashed log generating unit 22c, the hashed log receiving unit 22d, and the hashed log verifying unit 22e, respectively, as depicted in FIG. 10.

The HDD 610 is provided with a server log table 611, a management log table 612, an audit log table 613, a hashed management log table 614, and a hashed audit log table 615 as depicted in FIG. 26. The server log table 611, the management log table 612, the audit log table 613, the hashed management log table 614, and the hashed audit log table 615 correspond to the server log storage unit 23a, the management log storage unit 23b, the audit log storage unit 23c, the hashed management log storage unit 23d, and the hashed audit log storage unit 23e depicted in FIG. 10, respectively. The CPU 640 registers data in the server log table 611, the management log table 612, the audit log table 613, the hashed management log table 614, and the hashed audit log table 615. The CPU 640 reads out server log data 621, management log data 622, audit log data 623, hashed management log data 624, and hashed audit log data 625 from the server log table 611, the management log table 612, the audit log table 613, the hashed management log table 614, and the hashed audit log table 615, and stores them in the RAM 620. The CPU 640 executes process of managing information based on the server log data 621, the management log data 622, the audit log data 623, the hashed management log data 624, and the hashed audit log data 625 stored in the RAM 620.

According to the present invention, it becomes possible to refer to the entire logs while hashing information about another customer by the one-way function to maintain confidentiality; as a result, it becomes possible to protect personal information of a customer, and to execute appropriate audit.

According to the present invention, the hashed log is received directly from the center not bypassing a third party; as a result, it becomes possible for example to identify a cause of falsification easily, if found.

According to the present invention, the hashed log is received bypassing a third party, not directly from a center that manages a server; as a result, it becomes possible to execute more appropriate audit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions for implementing an auditing method of verifying validity of a log used in audit by receiving the log from a server at which a plurality of customers shares resources, wherein the instructions, when executed by a computer, cause the computer to perform:
receiving entire logs including a hashed log in which a log about another customer is hashed by a one-way function, and a log of a subject customer from the server;
hashing an unlashed log among the entire logs received at the receiving of the entire logs to generate a hashed log;
receiving the hashed log in which the entire logs are hashed; and
comparing the hashed log generated at the generating of the hashed log, and the hashed log received at the receiving of the hashed log with each other to verify log validity.

2. The computer readable storage medium according to claim 1, wherein, at the receiving of the hashed log, the hashed log is received from a center that manages the server.

3. The computer readable storage medium according to claim 1, wherein, at the receiving of the hashed log, the hashed log is received from another customer.

4. An auditing system that verifies validity of a log used in audit by receiving the log from a server at which a plurality of customers shares resources, the auditing system comprising:
an entire log receiving unit that receives entire logs including a hashed log in which a log about another customer is hashed by a one-way function, and a log of a subject customer from the server;
a hashed log generating unit that hashes an unlashed log among the entire logs received by the entire log receiving unit to generate a hashed log;
a hashed log receiving unit that receives the hashed log in which the entire logs are hashed; and
a log verifying unit compares the hashed log generated by the hashed log generating unit, and the hashed log received by the hashed log receiving unit with each other to verify log validity.

5. The auditing system according to claim 4, wherein the hashed log receiving unit receives the hashed log from a center that manages the server.

6. The auditing system according to claim 4, wherein the hashed log receiving unit receives the hashed log from another customer.

7. An auditing method of verifying validity of a log used in audit by receiving the log from a server at which a plurality of customers shares resources, the auditing method comprising:
receiving entire logs including a hashed log in which a log about another customer is hashed by a one-way function, and a log of a subject customer from the server;
hashing an unlashed log among the entire logs received at the receiving of the entire logs to generate a hashed log;
receiving the hashed log in which the entire logs are hashed; and
comparing the hashed log generated at the generating of the hashed log, and the hashed log received at the receiving of the hashed log with each other to verify log validity.

8. The auditing method according to claim 7, wherein, at the receiving of the hashed log, the hashed log is received from a center that manages the server.

9. The auditing method according to claim 7, wherein, at the receiving of the hashed log, the hashed log is received from another customer.
